(19) United States
(12) Patent Application Publication
(10) Pub. No.: US 2013/0235931 A1
(43) Pub. Date: Sep. 12, 2013

(54) MASKING VIDEO ARTIFACTS WITH COMFORT NOISE

(71) Applicant: APPLE INC., Cupertino, CA (US)

(72) Inventors: Yeping Su, Sunnyvale, CA (US); Hsi-Jung Wu, San Jose, CA (US); Chris Y. Chung, Sunnyvale, CA (US)

(73) Assignee: APPLE INC., Cupertino, CA (US)

(21) Appl. No.: 13/631,689

(22) Filed: Sep. 28, 2012

Related U.S. Application Data
(60) Provisional application No. 61/607,453, filed on Mar. 6, 2012.

(51) Int. Cl. H04N 7/24; H04N 7/32

(52) U.S. Cl. 375/240.12; 375/240.29; 375/E07.243; 375/E07.001

(57) ABSTRACT

A system and method is presented to mask artifacts with content-adaptive comfort noise. Encoder side analysis may determine initial comfort noise characteristics. Noise parameters may then be developed for each frame or sequence of frames that define comfort noise patches that mask the artifacts. At the decoder, a comfort noise patch can be fetched from memory or created based on the amplitude and spatial characteristics of the comfort noise specified in the noise parameters. The noise patch may additionally be scaled or otherwise adjusted to accommodate the capabilities and/or limitations of the specific decoder.

### CROSS-REFERENCE TO RELATED APPLICATION

The present application claims the benefit of co-pending U.S. provisional application Ser. No. 61/607,453, filed Mar. 6, 2012, entitled, “SYSTEM FOR MASKING VIDEO ARTIFACTS WITH COMFORT NOISE”, the disclosure of which is incorporated herein by reference in its entirety.

### BACKGROUND

Aspects of the present invention relate generally to the field of video processing, and more specifically to the elimination of noise and noise related artifacts in processed video.

In video coding systems, an encoder may code a source video sequence into a coded representation that has a smaller bit rate than does the source video and thereby achieve data compression. Using predictive coding techniques, some portions of a video stream may be coded independently (intra-coded I-frames) and some other portions may be coded with reference to other portions (inter-coded frames, e.g., P-frames or B-frames). Such coding often involves exploiting redundancy in the video data via temporal or spatial prediction, quantization of residuals and entropy coding. Previously coded frames, also known as reference frames, may be temporarily stored by the encoder for future use in inter-frame coding. Thus a reference frame cache stores frame data that may represent sources of prediction for later-received frames input to the video coding system. The resulting compressed data (bitstream) may be transmitted to a decoding system via a channel. To recover the video data, the bitstream may be decompressed at a decoder by inverting the coding processes performed by the encoder, yielding a received decoded video sequence.

Video coding often is a lossy process. When coded video data is decoded after having been retrieved from a channel, the recovered video sequence replicates but is not an exact duplicate of the source video. Moreover, video coding techniques may vary based on variable external constraints, such as bit rate budgets, resource limitations at a video encoder and/or a video decoder or the display sizes that are supported by the video coding systems. Thus, a common video sequence coded according to two different coding constraints (say, coding for a 4 Mbits/sec channel vs. coding for a 12 Mbits/sec channel) likely will introduce different types of data loss. Data losses that result in video aberrations that are perceptible to human viewers are termed “artifacts” herein.

In many coding applications, there is a continuing need to maximize bandwidth conservation. When video data is coded for consumer applications, such as portable media players and software media players, the video data often is coded at data rates of approximately 8-12 Mbits/sec and sometimes 4 MBits/sec from source video of 1280×720 pixels/frame, up to 30 frames/sec. At such low bit rates, artifacts are likely to arise in decoded video data. Moreover, the prevalence of artifacts is likely to increase as further coding enhancements are introduced to lower the bit rates of coded video data even further.

Furthermore, video decoding systems may have very different configurations from each other. For example, portable media players and portable devices may have relatively small display screens (say, 2-5 inches diagonal) and limited processing resources as compared to other types of video decoders. Software media players that conventionally execute on personal computers may have larger display screens (11-19 inches diagonal) and greater processing resources than portable media players. Dedicated media players, such as DVD players and Blue-Ray disc players, may have digital signal processors devoted to the decoding of coded video data and may output decoded video data to much larger display screens (30 inches diagonal or more) than portable media players or software media players. Accordingly, as video encoding systems code source video, often their coding decisions may be affected by the processing resources available at an expected video decoder. Additionally, the encoding system may have greater resources than a decoder and certain decoding processes may not be available at the decoder. Similarly, certain artifacts or errors may be more or less visible depending on the resources of the decoder, including the size of the associated display.

Accordingly, there is a need in the art for systems and methods to dynamically mask the visual artifacts in coded video data, in a manner that adapts to video content and known noise characteristics as detected by the encoder.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified block diagram of a video coding system according to an embodiment of the present invention.

FIG. 2 is a simplified block diagram of a video encoder according to an embodiment of the present invention.

FIG. 3 is a simplified block diagram of a video encoder according to an embodiment of the present invention.

FIG. 4 is a simplified flow diagram illustrating a method for coding a sequence of frames according to an embodiment of the present invention.

FIG. 5 is a simplified block diagram of a video decoder according to an embodiment of the present invention.

FIG. 6 is a simplified flow diagram illustrating a method for decoding coded video data to an embodiment of the present invention.

FIG. 7 is a simplified diagram illustrating an exemplary syntax for noise parameters according to an embodiment of the present invention.

FIG. 8 is a simplified flow diagram illustrating a method for coding video data according to an embodiment of the present invention.

FIG. 9 is a simplified flow diagram illustrating a method for decoding coded video data according to an embodiment of the present invention

### DETAILED DESCRIPTION

A system and method is presented to mask artifacts with content-adaptive comfort noise. The noise identified in source data as well as noise related to the compression and decompression process may be evaluated. Encoder side analysis may determine initial comfort noise characteristics that may then be tailored to the context of the decoder, including for example display characteristics and viewing conditions. Noise parameters may be developed for each frame or sequence of frames that define the comfort noise patches that may mask the artifacts.

At the decoder, a comfort noise patch can be fetched from memory or created based on the amplitude and spatial characteristics of the comfort noise specified in the noise parameters. The generation of comfort noise at the decoder can be simplified based on the capabilities of the decoder.

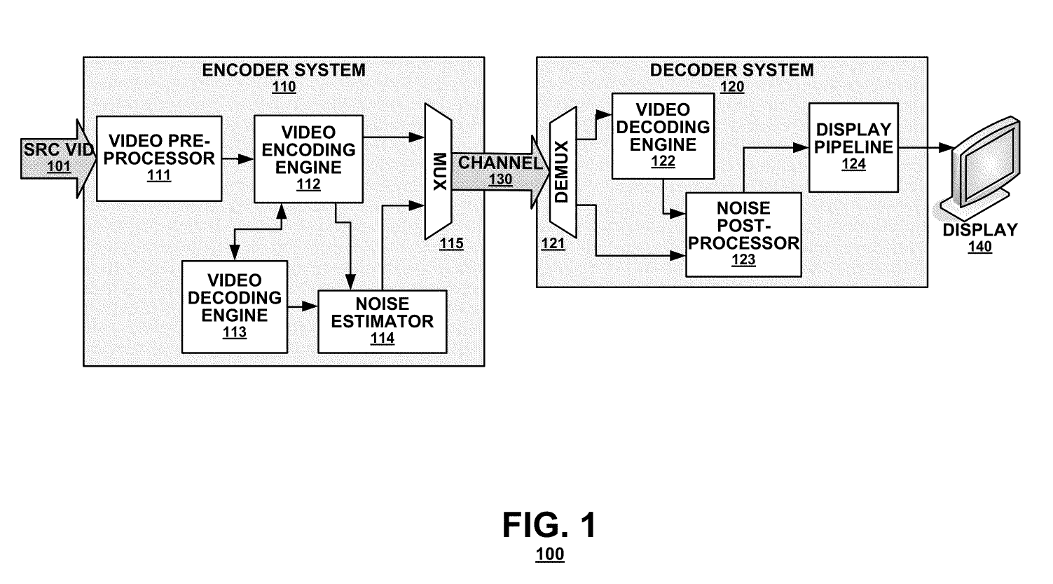

FIG. 1 is a simplified block diagram of a video coding system 100 according to an embodiment of the present invention. The system may include an encoder system 110 and a decoder system 120 that are connected via a channel 130. The channel may deliver coded video data output from the encoder system 110 to the decoder system 120. The channel may be a storage device, such as an optical, magnetic or electrical storage device, or a communication channel formed by computer network or a communication network for example either a wired or wireless network.

As shown in FIG. 1, the encoder system 110 may include a pre-processor 111 that receives source video 101 from a camera or other source and may parse the source video 101 into components for coding, an encoding engine 112 that codes processed frames according to a variety of coding modes to achieve bandwidth compression, a video decoding engine 113 that decodes coded video data generated by the encoding engine, a noise estimator 114 to generate noise parameters for the coded video data, and a multiplexer (MUX) 115 to store the coded data and combine the coded data and the noise parameters into a common bit stream to be delivered by the channel 130.

The pre-processor 111 may additionally perform video processing operations on the components including filtering operations or other operations that may improve the efficiency of coding operations performed by the encoding engine 112. Typically, the pre-processor 111 may analyze and condition the source video 101 for more efficient compression. For example, a video pre-processor 111 may perform noise filtering in an attempt to eliminate noise artifacts that may be present in the source video sequence. Often, such noise appears as high frequency, time-varying differences in video content, which can limit the compression efficiency of a video coder.

The encoding engine 112 may select from a variety of coding modes to code the video data, where each different coding mode yields a different level of compression, depending upon the content of the source video 101. Typically, the encoding engine 112 may code the processed source video according to a known protocol such as H.263, H.264, MPEG-2 or MPEG-7. The encoding engine 112 may code the processed source video according to a predetermined multi-stage coding protocol. Such video coding processes typically involve content prediction, residual computation, coefficient transforms, quantization and entropy coding. For example, common coding engines parse source video frames according to regular arrays of pixel data (e.g., 8×8 or 16×16 blocks), called “pixel blocks” herein, and may code the pixel blocks according to block prediction and calculation of prediction residuals, quantization and entropy coding.

The decoding engine 113 may generate the same decoded replica of the source video data that the decoder system 120 will generate, which can be used as a basis for predictive coding techniques performed by the encoding engine. The decoding engine 113 may access a reference frame cache (not shown) to store frame data that may represent sources of prediction for later-received frames input to the video coding system. Both the encoder system 110 and decoder system 120 may buffer reference frames.

The noise estimator 114 may be configured to analyze the source video 101, the coded video data bitstream, and/or the decoded video to produce a set of parameters that describe the coded video data. The produced parameters may be used by the decoder system 120 to produce a comfort noise signal based on the characteristics of the coded video data. The produced parameters may include an amplitude of a noise patch that may mask detected artifacts in the regenerated video data and the x and y spatial characteristics of the noise patch. According to an embodiment, the noise estimator 114 may develop a noise map for the noise detected in the source video 101 (for example, during pre-processing) and transmit the source noise map to the decoder system 120.

In an embodiment, the encoder system 110 may transmit noise parameters in logical channels established by the governing protocol for out-of-band data. As one example, used by the H.264 protocol, the encoder may transmit accumulated statistics in a supplemental enhancement information (SEI) channel specified by H.264. In such an embodiment, the MUX 115 represents processes to introduce the noise parameters in a logical channel corresponding to the SEI channel. When the present invention is to be used with protocols that do not specify such out-of-band channels, the MUX 115 may establish a separate logical channel for the noise parameters within the output channel 130.

As shown in FIG. 1, the decoder system 120 may include a demultipexer (DEMUX) 121 to receive the coded channel data and separate the coded video data from the noise parameters, a decoding engine 122 to receive coded video data and invert coding processes performed by the encoding engine 112, a noise post-processor 123, and a display pipeline 124 that represents further processing stages (buffering, etc.) to output the final decoded video sequence to a display device 140.

According to an embodiment, the decoder system 120 may receive noise parameters in logical channels established by the governing protocol for out-of-band data. As one example, used by the H.264 protocol, the decoder may receive noise parameters in a supplemental enhancement information (SEI) channel specified by H.264. In such an embodiment, the DEMUX 121 represents processes to separate the noise parameters from a logical channel corresponding to the SEI channel. However, when the present invention is to be used with protocols that do not specify such out-of-band channels, the DEMUX 121 may separate the noise parameters from the encoded video data by utilizing a logical channel within the input channel 130.

The decoding engine 122 may parse the received coded video data to recover the original source video data, for example by decompressing the frames of a received video sequence by inverting coding operations performed by the encoder system 110. The decoding engine 122 may access a reference frame cache to store frame data that may represent source blocks and sources of prediction for later-received frames input to the decoding system 120.

The noise post-processor 123 may generate a comfort noise patch for the video data and prepare the decompressed video for display by applying noise patch(es) to artifacts in the recovered video data to mask them. According to an embodiment, noise patches may be identified using the parameter information transmitted from the encoder system 110 in the channel data. The post-processor 123 also may perform other post-processing operations such as deblocking, sharpening, upscaling, etc. cooperatively in combination with the noise masking processes described herein.

According to an embodiment, the coding system 100 may include terminals that communicate via a network. The terminals each may capture video data locally and code the video data for transmission to another terminal via the network. Each terminal may receive the coded video data of the other terminal from the network, decode the coded data and display the recovered video data. Video terminals may include personal computers (both desktop and laptop computers), tablet computers, handheld computing devices, computer servers, media players and/or dedicated video conferencing equipment. As shown in FIG. 1, a pair of terminals are represented by the encoder system 110 and the decoder system 120. As shown, the coding system 100 supports video coding and decoding in one direction only. However, according to an embodiment, bidirectional communication may be achieved with an encoder and a decoder implemented at each terminal.

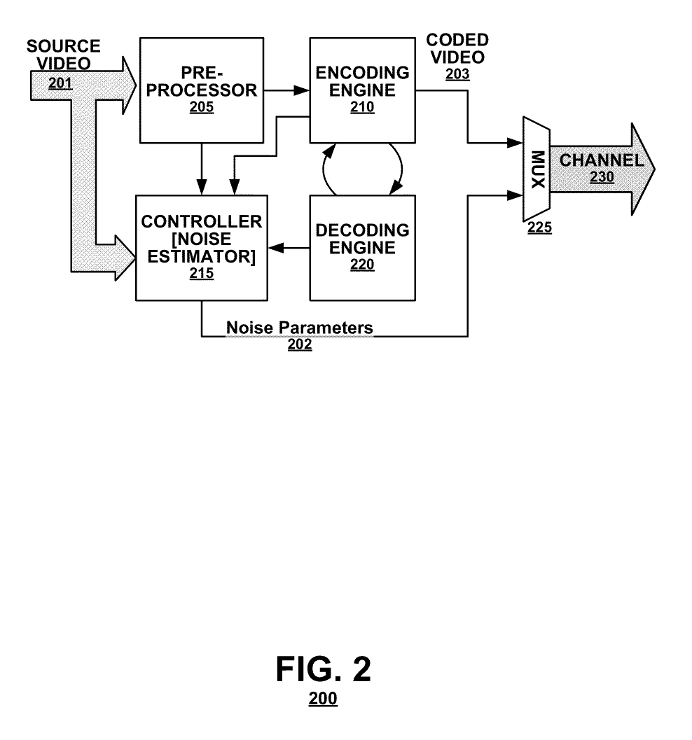

FIG. 2 is a simplified block diagram of a video encoder 200 according to an embodiment of the present invention. The video encoder 200 may include a pre-processor 205, an encoding engine 210, and a decoding engine 220 as indicated above. As shown in FIG. 2, the video encoder 200 may additionally include a noise estimator 215.

The amount of noise existent in the source video data 201 or coded video data 203 identified by the noise estimator 215 may be estimated with any known noise estimation technique. Then the amount of comfort noise to be applied at a decoder system may be limited by the amount of identified or estimated source noise. For example, using image-processing techniques, the noise estimator 215 can identify and analyze flat regions in the image wherein signal fluctuations may be predominantly noise rather than objects and edges in the captured scene. Additionally, sensor meta-data from a source camera may provide noise statistics without necessitating an analysis of the pixel data. Furthermore, for noise generated during a pre-processing or encoding stage, the noise estimator 215 may have direct access to certain noise statistics.

According to an embodiment, the noise estimator 215 may estimate visual artifacts from a comparison of the source video data 201 and the recovered video data generated by the video decoding engine 220 and determine noise parameters appropriate to mask the detected artifacts. The noise estimator 215 may additionally identify regions of the recovered video where visual artifacts have appeared. If artifacts are detected in the recovered video data, the noise estimator 215 may set the noise parameters 202 to a higher amplitude and/or such that the comfort noise is more spatially correlated.

The noise estimator 215 may further detect banding, blocking, ringing or other similar artifacts and adjust the noise parameters 202 to mask such detected artifacts. Banding may be detected in image regions with smooth gradients by identifying gradients in the source image and low amplitude edges in the decoded image. The noise estimator 215 may also detect blocking artifacts by analyzing signal discontinuity across codec block boundaries not present in the source video. Similarly, ringing artifacts can be detected by identifying low amplitude ripples near strong object edges.

According to an embodiment, the noise estimator 215 may estimate that certain regions of an image are likely to have artifacts based on a complexity analysis of those regions. For example, artifacts may be perceptible in regions that possess semi-static, relatively flat image data. However, similar artifacts would be less perceptible in regions that possess relatively large amounts of structure or possess large amounts of motion. Then the noise estimator 215 may estimate artifacts from an examination of quantization parameters, motion vectors and coded DCT coefficients of image data.

Quantization parameters and DCT coefficients typically are provided for each coded block and/or each coded block of a frame (collectively, a “pixel block”). Pixel blocks that have a relatively low concentration of DCT coefficients in an AC domain or generally high quantization parameters may be considered to have generally flat image content. If a group of pixel blocks are determined to have flat image content, the noise estimator 215 may estimate that the pixel blocks are likely to have artifacts. However, pixel blocks with a relatively high concentration of AC coefficients or relatively low quantization parameters may be estimated as unlikely to have artifacts.

The noise estimator 215 may additionally consider motion vectors calculated during coding. The noise estimator 215 may analyze motion vectors for pixel blocks throughout a plurality of frames and estimate the likelihood that artifacts will be present based on the consistency of the motion vectors. If multiple pixel blocks exhibit generally consistent motion across a plurality of frames, these pixel blocks may be estimated to have a relatively low likelihood of artifacts. However, if the pixel blocks exhibit divergent motion across a plurality of frames, the region may be identified as likely having artifacts.

Additionally, the artifact estimator may consider a pixel block's coding type as an indicator of artifacts. For example, certain coding modes utilize SKIP blocks which are coded without motion vectors. SKIP blocks may yield a very low coding rate, but are also more likely to induce artifacts in recovered video. The noise estimator 215 may identify these edges and select noise parameters 202 to mask these artifacts.

Each of the various components of the encoder 200 may additionally provide information to the noise estimator 215 that may be used to identify noise in the source video data 201 or coded video data 203. For example, as previously noted, the pre-processor 205 may receive a sequence of source video data 201 and may perform pre-processing operations that condition the source video for subsequent coding. Such pre-processing operations may include noise filtering to eliminate noise components from the source video 201. Such noise filtering may remove high frequency spatial and temporal components from the source video 201. Accordingly, the noise filtering performed by the pre-processor 205 may be evaluated by the noise estimator 215 to determine a noise map of the source video data 201 that may be used to calculate noise parameters.

According to an embodiment, the noise estimator 215 may consider temporal irregularities to apply the right amount of comfort noise to decoded images. For example, the noise estimator 215 may track source noise statistics and coding noise statistics in a group of frames, and then set the comfort noise parameters 202 such that the output video data will have fewer perceived noise variations.

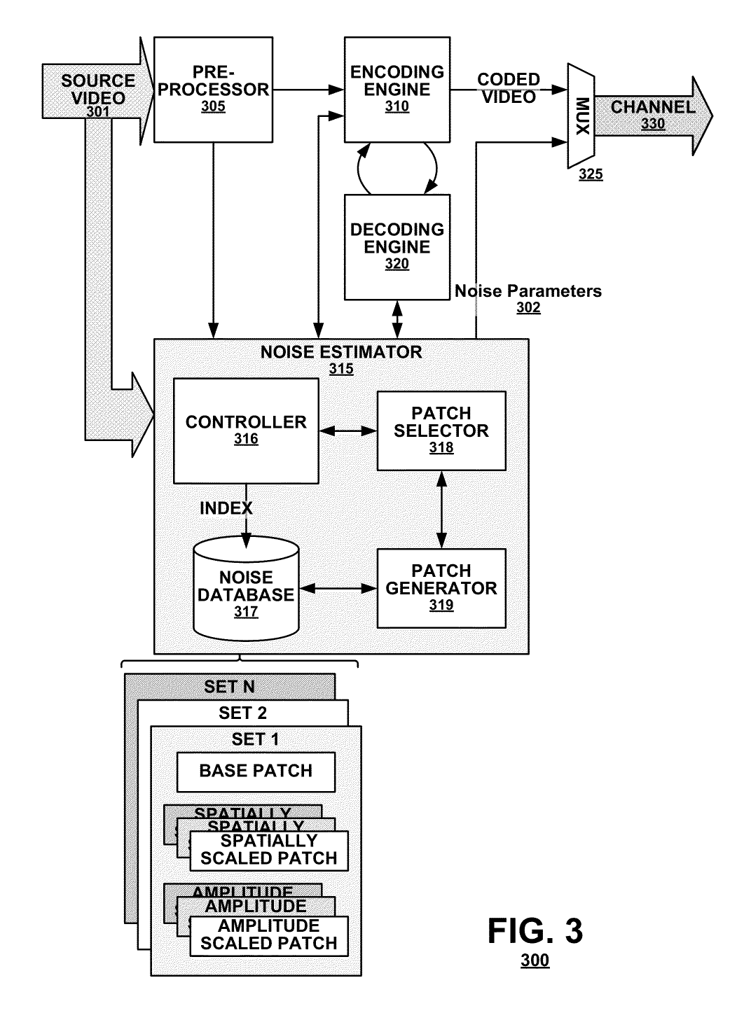

FIG. 3 is a simplified block diagram of a video encoder 300 according to an embodiment of the present invention. The video encoder 300 may include a pre-processor 305, an encoding engine 310, and a decoding engine 320 as indicated above. According to an embodiment, the video encoder 300 may additionally include a noise estimator 315 having a controller 316, a patch selector 318, a noise database 317, and a patch generator 319 with which the video encoder 300 can identify specific noise patches that may mask the detected artifacts.

The noise estimator 315 may test a plurality of noise patches to identify a patch that provides the best noise masking detect artifacts. The patch selector 318 may select a patch (or combination of patches) from the patch database 317 to mask the identified artifacts. In an embodiment, the patch selector 318 may include an identifier of the selected patch in the channel with the coded video data. In another embodiment, when the patch selector 318 identifies the patches that are to be used by the decoder, the patch selector 318 also may estimate a patch derivation process that may be performed by the decoder. The patch selector 318 may determine whether the patches that would be derived by the decoder are sufficient to mask the artifacts identified by the noise estimator 315. If so, the patch selector 318 may refrain from including patch identifiers in the channel data. If not, if unacceptable artifacts would persist in the recovered video data generated by the decoder, then the patch selector 318 may include identifiers of the selected patches to override the patch derivation process that may occur at the decoder.

During operation, to determine whether a selected patch or combination of patches adequately mask detected artifacts, the patch selector may output the selected patches to the decoding engine 320, which emulates post-processing operations to merge the selected noise patches with the decoded video data. The noise estimator 315 may repeat its artifact estimation processes on the post-processed data to determine if the selected patches adequately mask the previously detected artifacts. If so, the selected patches may be confirmed. If not, the patch selector may attempt another selection. Patch selection may occur on a trial and error basis until an adequate patch selection is confirmed.

According to an embodiment, the identification of an appropriate noise patch may be performed by the pre-processor 305 and communicated to the noise estimator 315 when the pre-processor 305 performs noise filtering.

The noise estimator 315 may additionally create new noise patches. For example, to create a noise patch, the controller 316 may signal the decoding engine 320 to cause it to decode only the coded AC coefficients of a region, without including the DC coefficient(s). The resultant decoded data may be stored in the noise database 317 as a new noise patch. Moreover, when transmitting the coded data of the region to a decoder, the controller 316 may include a flag in the coded data to signal to a video decoder identifying the new noise patch.

According to an embodiment, the patch generator 319 may also generate new patches to be stored in the noise database 317. In an embodiment, when the noise database 317 does not currently store any patches that adequately mask detected artifacts, the patch selector 318 may engage the patch generator 317, which may compute a new patch for use with the identified artifact. If the noise database 317 is full, a previously-stored patch may be evicted according to a prioritization scheme. Then, as previously noted, the controller 316 may communicate the new patch definition to a decoder in a sideband message.

In a further embodiment, the encoder 300 may estimate artifacts in the recovered video data by comparing the recovered video data to the source video data 301. Then the patch selector 318 may model a patch derivation process that is likely to be performed by a decoder. The patch selector 318 may determine whether the patches derived by the decoder are sufficient to mask the identified artifacts. If so, the patch selector 318 may refrain from including patch identifiers in the channel data. However, if unacceptable artifacts would persist in the recovered video data generated by the decoder, then the controller 316 may include identifiers of the selected patch(es) to override the patch derivation process that will occur at the decoder. Thus an encoder 300 may define noise patterns implicitly in the coded video data 303 without sending express definitions of noise patches in SEI messages.

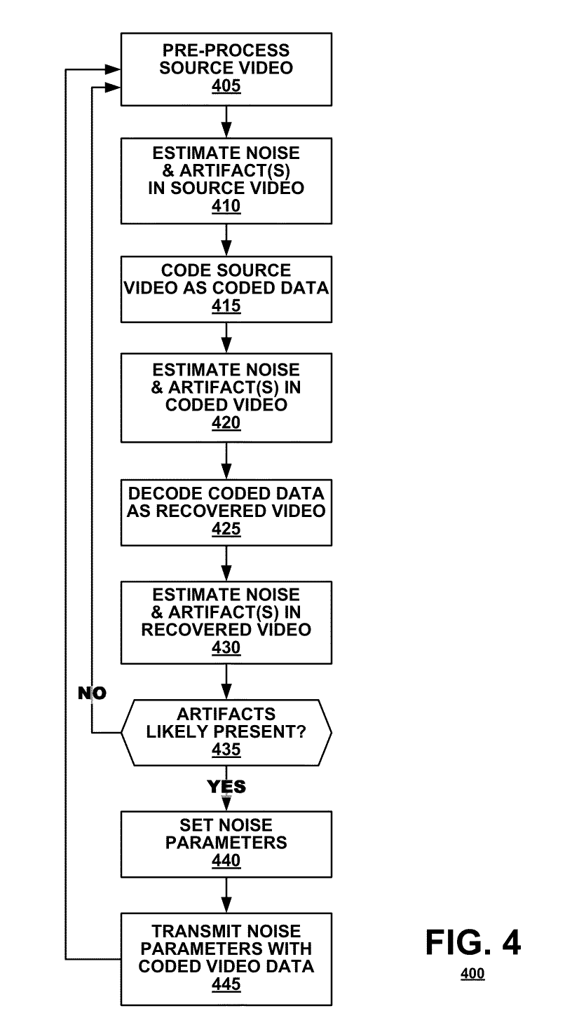

FIG. 4 is a simplified flow diagram illustrating a method 400 for coding a sequence of frames according to an embodiment of the present invention. Preliminarily, the source video may be received at the encoder and pre-processed to facilitate coding (block 405). The pre-processing statistics may then be passed to a noise estimator to identify source noise (block 410). Then the processed source video may be encoded according to conventional predictive coding techniques (block 415) and the coding statistics may be passed to the noise estimator to identify coding noise and artifacts (block 420). Once the coded data is decoded to generate recovered video data (block 425), the recovered video data may be compared to the source data to identify artifacts (block 430).

If artifacts or noise worth masking are detected (block 435), the method may identify the noise parameters that define a noise patch that will mask the detected noise and artifacts (block 440). The noise parameters may then be combined with the encoded video data on a channel and transmitted to a receiver, a decoder, or storage (block 445).

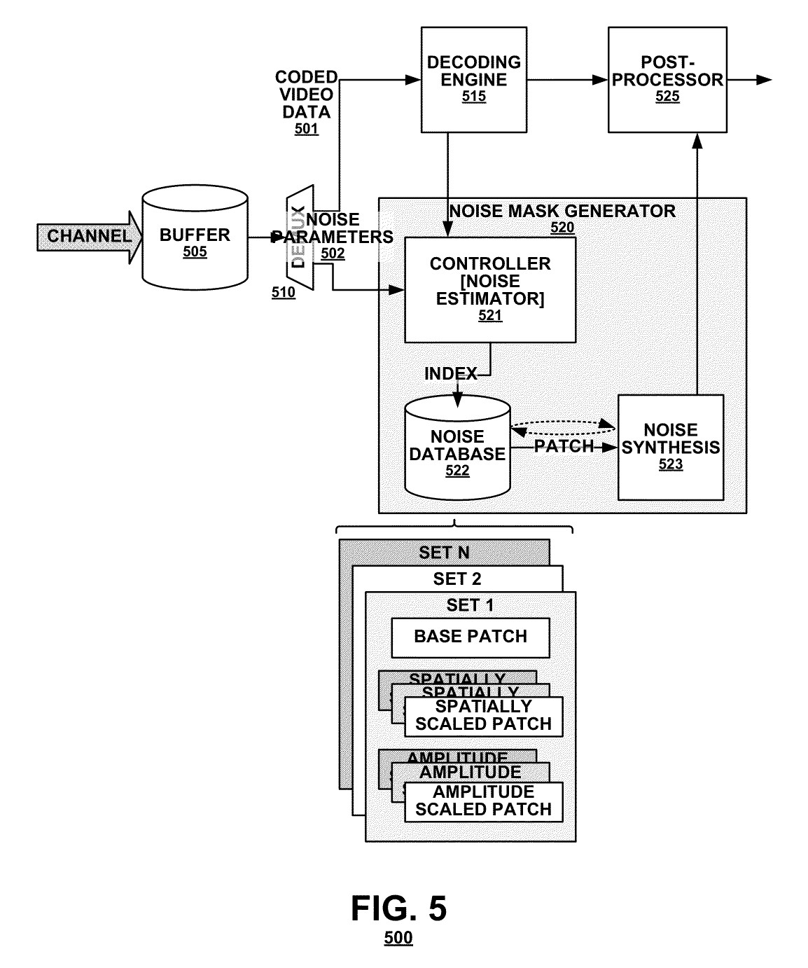

FIG. 5 is a simplified block diagram of a video decoder 500 according to an embodiment of the present invention. The decoder 500 may include a coded picture buffer 505, a demultiplexer 510 that separates the data received from the channel into multiple channels of data including the coded video data 501 and the associated noise parameters 502, a decoding engine 515 to decode coded data by inverting coding processes performed at a video encoder and to generate recovered video, and a post-processor 525. The masking processes described herein may be part of the post-processing techniques that can be performed by a decoding system. For ease of discussion, noise masking processes are represented by a noise mask generator 520 and other conventional post-processing techniques are represented by post-processor 525.

The noise mask generator 520 may identify noise patches to be applied to the recovered video data to mask artifacts detected in the video data based on the received noise parameters 502. The noise mask generator 520 may select a predefined patch or generate an appropriate patch. The noise mask generator 520 may store a plurality of noise patches from which an appropriate patch may be selected.

The selection of a noise patch may additionally be based upon the available resources of the decoder 500. For example, the selection may be based in part on the display size associated with the decoder where an artifact may not be perceptible on a small display but would otherwise be noticeable on a larger display. Similarly, a decoder with greater resources to allocate for post-processing operations than a smaller decoder may have fewer perceptible artifacts. Accordingly, the noise mask generator's estimation of the significance of detected noise artifacts may be based on the size of the decoder's associated display as well as the processing resources that are available at the decoder.

Furthermore, the noise mask generator 520 may scale selected patches according to the display size and the noise parameters 502. Typically, the video decoder 500 will generate a recovered video sequence where each frame has a predetermined size but the associated display may have a different size. A post-processor 525 may scale the recovered video data, spatially enlarging it or decimating it, by a predetermined factor to fit the recovered video to the display. Similarly, the noise mask generator 520 may scale noise patches by a predetermined scale factor corresponding to the post-processor's rescale factor or according to the shape parameters received as part of the noise parameters 502.

As shown in FIG. 5, the noise mask generator 520 may include a noise database 522 that stores various noise patches of varying patterns, sizes and magnitudes and a noise synthesis unit 523 that generates a final noise pattern from one or more noise patches and outputs the final noise pattern to the post-processor 525. The noise database 522 may store base patches of a variety of sizes. For example, it may be convenient to store base patches that have the same size as the pixel blocks utilized in a coding protocol (e.g. H.263, H.264, MPEG-2, MPEG-4 Part 2). Similarly, base patches may be sized to coincide with the sizes of “slices” as defined in the governing coding standard.

Noise patches may be stored to the noise database 522 in a variety of ways. Noise patches may be preprogrammed in the database and, therefore, can be referenced directly by both the encoder system and the decoder system during operation. Alternatively, the encoder can communicate data defining new patches and include them in the channel data. In such an embodiment, the decoder 500 may distinguish the coded video data from the patch definition data and route the different data to the video decoding engine 515 and the noise mask generator 520 respectively. For example, the encoder can include patch definitions in an SEI message. According to an embodiment, noise patches may be coded as run-length encoded DCT coefficients representing noise patterns.

According to an embodiment, noise patterns may be defined by the received noise parameters 502 and derived by a noise mask generator 520. A noise estimator 521 may then correlate received noise parameters 502 to predefined noise patches. With a received set of noise parameters 502, the corresponding noise patch may be retrieved and scaled by the parameter level/strength parameter before being added to the decoded video. According to another embodiment, a noise patch may be generated by the noise mask generator 520 upon receipt of the noise parameters 502, for example through a controllable noise synthesizer 523. A recursive filter may be used to generate correlated noise according to Equation 1:

O(x, y)=a*O(x−1, y−1)+b*O(x, y−1)+c*O(x+1, y−1)+d*O(x−1, y)+e*G EQ. 1

where G is a random number and [a, b, c, d, e] is a set of filter coefficients looked up at the noise estimator 521 based on the received noise parameters 502. As shown in Equation 1, the spatial support of the recursive filter may use four previously generated pixels. However, the use of previously generated pixels may be made variable to balance complexity and model efficacy.

In accordance with an embodiment, both implied derivation of noise patches by a noise mask generator 520 and identification of known noise patches from the received noise parameters 502 may be utilized to determine an appropriate noise patch. For example, patches my be selected to mask coding artifacts based on the artifacts detected in the recovered video data and the received noise parameters 502. However, if an encoder models the patch derivation process of the decoder 500 and estimates any errors that would be induced by the decoder's noise patch selection as compared to the source video, the encoder may adjust the noise parameters 502 to correlate to a known noise patch that provides better performance. The noise mask generator 520 may then implement an override for patch derivation when a patch is identified in the received noise parameters 502.

In accordance with an embodiment, the noise mask generator 520 may select noise patches on a trial-and-error basis and integrate them with recovered video data. Then the integrated data may be analyzed for perceptible artifacts to determine the success of the selected patch.

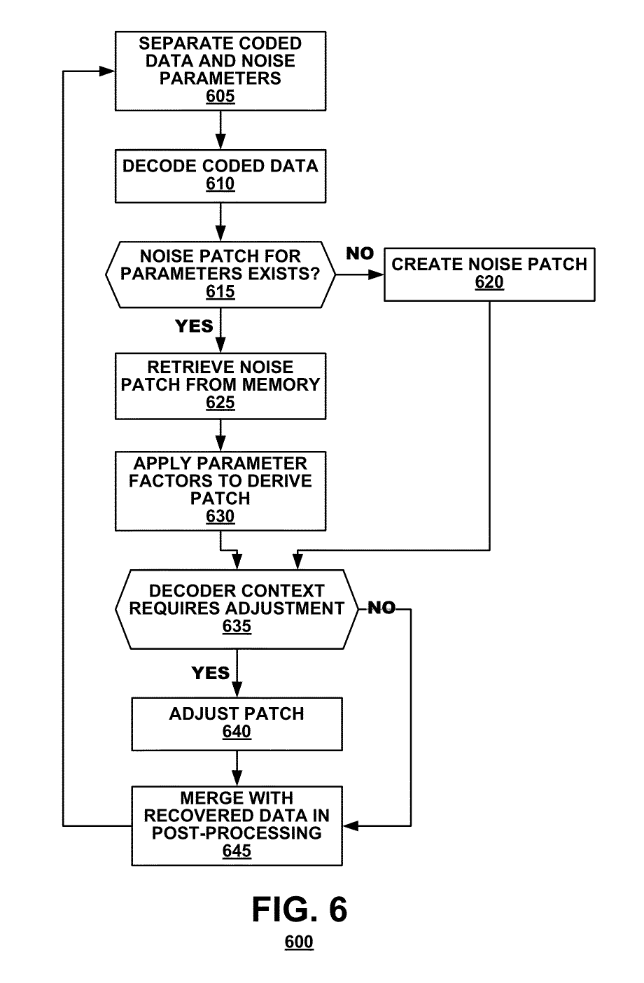

FIG. 6 is a simplified flow diagram illustrating a method 600 for decoding coded video data to an embodiment of the present invention. As shown in FIG. 6, video data may be received by a decoder and the coded video separated from noise parameters (block 605). Then the coded video data may be decoded to generate recovered video data (block 610). Using the noise parameters, if a noise patch that correlates to the received noise parameters exists (block 615), the appropriate noise patch may be retrieved from memory (block 625). Then the retrieved noise patch may be adjusted according to the noise parameters (block 630). However, if a noise patch that correlates to the received noise parameters does not exist (block 615), an appropriate noise patch may be created (block 620).

Once an appropriate noise patch has been identified or created, if the specific resources of the decoder required adjustment (block 635), the noise patch may be scaled or otherwise adjusted according to the available resources of the decoder (block 640). For example, the recovered video data and noise patch may be scaled to fit the display associated with the decoder. Once the noise patch is complete, the noise patch may then be merged with the decoded frame in the recovered video data (block 645). The recovered video may then be further processed and prepared for display, and then displayed on a display device.

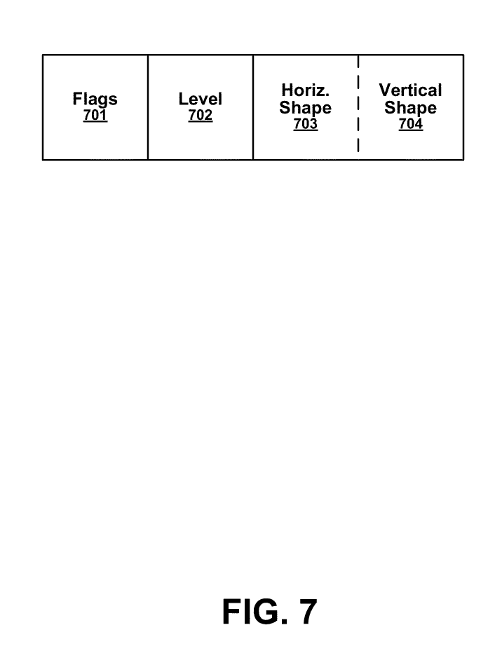

FIG. 7 is a simplified diagram illustrating an exemplary syntax for noise parameters according to an embodiment of the present invention. As shown in FIG. 7, noise parameters may include a strength parameter 702 which controls the amplitude of the applied noise, spatial characteristic parameters 703, 704 which control the spatial fatness of the applied noise, and one or more flag parameters 701 to enable the use of the transmitted parameters. The spatial characteristics may consist of both a horizontal shape and a vertical shape of the applied noise. The flag parameters 701 may additionally identify applicability of the noise parameters to different color channels.

As previously noted, in accordance with an embodiment, the noise parameters may be transmitted from an encoder to a decoder in logical channels established by the governing protocol for out-of-band data. As one example, used by the H.264 protocol, the decoder may receive noise parameters in a supplemental enhancement information (SEI) or a video usability information (VUI) channel of H.264. When the noise parameters are to be used with protocols that do not specify such out-of-band channels, the parameters may be transmitted between terminals by utilizing a logical channel within the output channel.

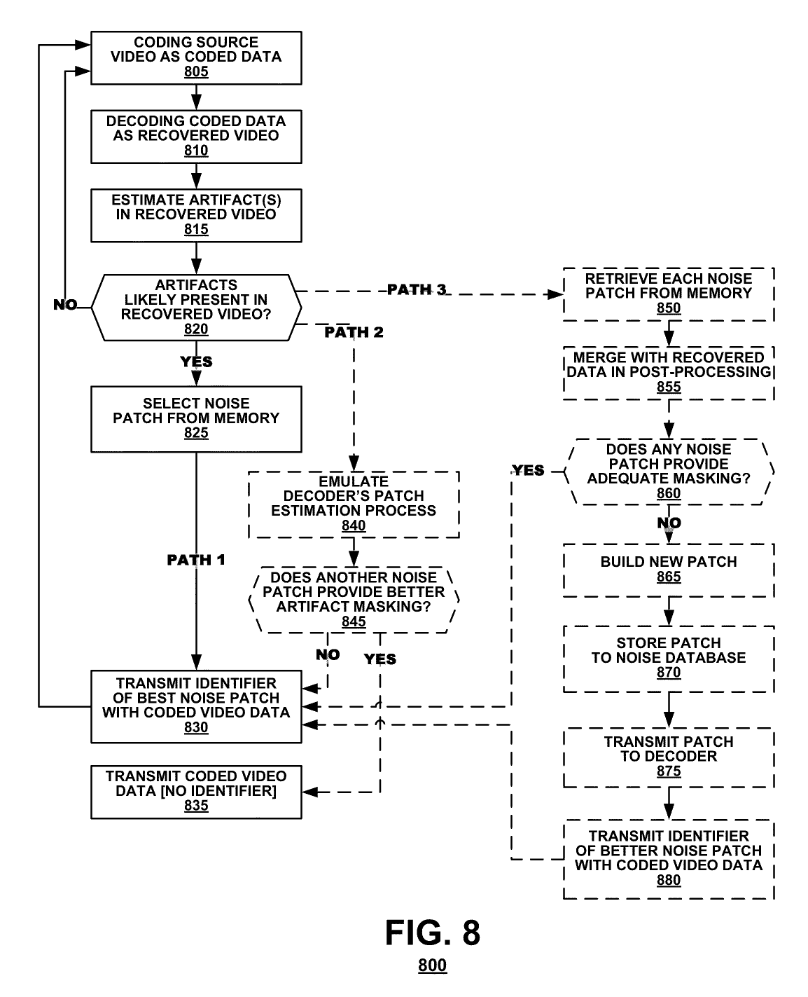

FIG. 8 is a simplified flow diagram illustrating a method 800 for coding video data according to an embodiment of the present invention. As shown in FIG. 8, the source video may be coded as coded data (block 805) and then the coded data may be subsequently decoded (block 810) to generate recovered video data that simulates the decoded data that may be recovered at a decoder system.

The encoder may then estimate whether artifacts are likely to exist in the recovered video data (blocks 815, 820). If artifacts are likely to be present, the encoder may identify a noise patch that is estimated to mask the detected artifact(s) (block 825). The encoder may transmit an identifier of the selected noise patch to the decoder in noise parameter data along with the coded data (block 830).

In accordance with an alternative embodiment, shown as path 2 in FIG. 8, after having determined that artifacts likely are present in recovered video data (block 820), the encoder may emulate a decoder's patch estimation process (block 840). The method may determine whether its noise patch database stores a noise patch that provides better masking of artifacts than the noise patch identified by the emulation process (block 845). For example, the encoder may perform post-processing operations using multiple noise patches and determine, by comparison to the source video, whether another noise patch provides recovered data that more accurately matches the source video than the noise patch identified by the emulation process. If a better noise patch exists, the encoder may transmit an identifier of the better noise patch in the noise parameter data with the coded data (block 830). If no better noise patch was identified, the encoder may transmit the coded video data to the channel without an identification of any specific noise patch (block 835).

According to an alternative embodiment as shown in path 3 of FIG. 8, after having determined that artifacts likely are present in recovered video data (block 820), the encoder may process multiple noise patches in memory. The encoder may retrieve each noise patch and add it to the recovered video data in a post-processing operation (blocks 850, 855). The encoder may then determine, for each such noise patch, whether the noise patch adequately masks the predicted noise artifacts (block 860). If so, the noise patch is identified as adequate and the encoder may identify the noise patch in the channel bit stream (for example by identifying it expressly or omitting its identifier if the decoder would select it through the decoder's own processes (blocks 830,835)). If none of the previously-stored noise patches sufficiently mask the estimated artifacts, then the encoder may build a new noise patch and store it to memory (blocks 865, 870). Further, the method may code the new noise patch and transmit it in the channel to the decoder (block 875), for example, by coding the noise pattern as quantized, run length coded DCT coefficients. Finally, the method may include an identifier of the new noise patch with the noise parameters transmitted with the coded video data (block 880).

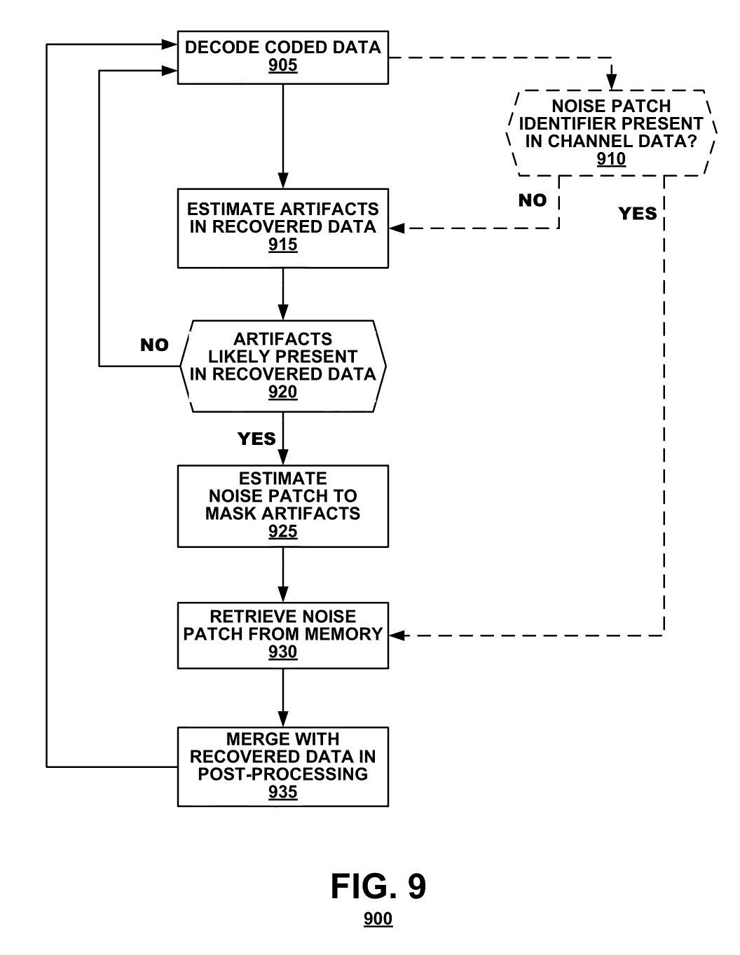

FIG. 9 is a simplified flow diagram illustrating a method 900 for decoding coded video data according to an embodiment of the present invention. As shown in FIG. 9, a decoder may decode coded data (block 905) to generate recovered video data therefrom. Then the decoder may estimate whether artifacts are likely to exist in the recovered video data (block 915-920). If artifacts are likely to be present, the decoder may identify a noise patch that is estimated to mask the artifact (block 925). The decoder may then retrieve the identified noise patch from memory (block 930) and apply the patch to the affected region of recovered video data in a post-processing operation (block 935).

In accordance with an alternative embodiment, the encoder may determine whether a noise patch identifier is present in the noise parameters or other channel data (block 910). If a noise patch identifier is received, several operations (blocks 915-925) may be skipped and the encoder may retrieve (block 930) and apply the identified noise patch (block 935).

As discussed above, FIGS. 1, 2, 3, and 5 illustrate functional block diagrams of terminals. In implementation, the terminals may be embodied as hardware systems, in which case, the illustrated blocks may correspond to circuit sub-systems. Alternatively, the terminals may be embodied as software systems, in which case, the blocks illustrated may correspond to program modules within software programs. In yet another embodiment, the terminals may be hybrid systems involving both hardware circuit systems and software programs. Moreover, not all of the functional blocks described herein need be provided or need be provided as separate units. For example, although FIG. 2 illustrates the components of an exemplary encoder, such as the pre-processor 205 and coding engine 222, as separate units, in one or more embodiments, some components may be integrated. Such implementation details are immaterial to the operation of the present invention unless otherwise noted above.

Similarly, the encoding, decoding, artifact estimation and post-processing operations described with relation to FIGS. 4, 6, 8, and 9 may be performed continuously as data is input into the encoder/decoder. The order of the steps as described above does not limit the order of operations. For example, depending on the encoder resources, the source noise may be estimated at substantially the same time as the processed source video is encoded or as the coded data is decoded. Additionally, some encoders may limit the detection of noise and artifacts to a single step. For example, by only estimating the artifacts present in the recovered data as compared to the source data, or only by using the coding statistics to estimate noise.

The foregoing discussion demonstrates dynamic use of stored noise patches to mask visual artifacts that may appear during decoding of coded video data. Although the foregoing processes have been described as estimating a single instance of artifacts in coded video, the principles of the present invention are not so limited. The processes described hereinabove may identify multiple instances of artifacts whether they be spatially distinct in a common video sequence or temporally distinct or both.

Some embodiments may be implemented, for example, using a non-transitory computer-readable storage medium or article which may store an instruction or a set of instructions that, if executed by a processor, may cause the processor to perform a method in accordance with the disclosed embodiments. The exemplary methods and computer program instructions may be embodied on a non-transitory machine readable storage medium. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device.

While the invention has been described in detail above with reference to some embodiments, variations within the scope and spirit of the invention will be apparent to those of ordinary skill in the art. Thus, the invention should be considered as limited only by the scope of the appended claims.

1. A video coding method, comprising:
for each frame in a sequence of video frames, identifying perceptible artifacts;
for each identified artifact, determining a noise patch to mask the artifact;
defining the determined noise patch with a set of noise parameters;
coding the sequence of frames; and
transmitting the noise parameters with each associated coded frame on a channel.

2. The method of claim 1, further comprising: decoding the coded sequence of video frames to derive recovered video frames.

3. The method of claim 2, wherein said artifacts are identified in the recovered video frames.

4. The method of claim 2, wherein said identifying further comprises:
for each frame in the sequence of frames, comparing the recovered video frame to a source video frame; and
identifying differences between the recovered video frame and the source video frame.

5. The method of claim 1, wherein said identifying further comprises: identifying an estimation of noise removed from the frame during a pre-processing stage.

6. The method of claim 1, wherein said identifying further comprises: identifying an estimation of noise in a source frame from metadata defining camera capture statistics for the frame.

7. The method of claim 2, wherein said identifying further comprises: identifying gradients in a source frame and low amplitude edges in a recovered frame to identify banding artifacts.

8. The method of claim 2, wherein said identifying further comprises: analyzing signal discontinuities across pixel block boundaries to identify blocking artifacts.

9. The method of claim 2, wherein said identifying further comprises: identifying low amplitude pixels near object edges to identify ringing artifacts.

10. The method of claim 1, wherein said identifying further comprises: identifying a flat region in a frame and a difference between a plurality of pixels in the region greater than a predetermined threshold.

11. The method of claim 1, wherein said identifying further comprises: identifying an estimation of noise based on a coding parameter used with the frame during encoding.

12. The method of claim 1, wherein the noise parameters include an amplitude of the determined noise patch.

13. The method of claim 1, wherein the noise parameters include spatial characteristics of the determined noise patch.

14. The method of claim 13, wherein the spatial characteristics include a horizontal shape and a vertical shape for the determined noise patch.

15. The method of claim 1, wherein the noise parameters include a flag indicating the existence of parameters defining the determined noise patch.

16. The method of claim 1, wherein said determining further comprises: retrieving a predefined noise patch from a noise patch database.

17. The method of claim 16, wherein said determining further comprises: testing a plurality of predefined noise patches to identify a noise patch that masks the identified artifact.

18. The method of claim 16, wherein said determining further comprises: scaling the predefined noise patch.

19. The method of claim 1, wherein said determining further comprises: creating a new noise patch to mask the identified artifact.

20. A video decoding method, comprising:
at a decoder, receiving coded video data and associated noise parameters on a channel;
decoding the coded video data;
identifying a noise patch corresponding to the noise parameters; and
merging the identified noise patch and the decoded video data.

21. The method of claim 20, wherein said identifying further comprises: retrieving a predefined noise patch from a noise patch database.

22. The method of claim 20, wherein said determining further comprises: creating a new noise patch according to the noise parameters.

23. The method of claim 20, further comprising: adjusting the identified noise patch according to a context of the decoder.

24. The method of claim 21, wherein said context includes a display size.

25. The method of claim 21, wherein said adjusting further comprises: scaling the noise patch.

26. The method of claim 20, wherein the noise parameters include an amplitude of the noise patch.

27. The method of claim 20, wherein the noise parameters include spatial characteristics of the noise patch.

28. The method of claim 27, wherein the spatial characteristics include a horizontal shape and a vertical shape for the noise patch.

29. The method of claim 20, wherein the noise parameters include a flag indicating the existence of a noise patch definition in the noise parameters.

30. The method of claim 29, wherein if the noise parameters do not include a flag indicating the existence of a noise patch definition, identifying an artifact in the decoded video data and determining a noise patch to mask the artifact.

31. The method of claim 30, wherein said determining further comprises: testing a plurality of predetermined noise patches to identify a noise patch that masks the identified artifact.

32. A video coder, comprising:
a coding engine configured to predictively code a sequence of video frames;
a noise estimator configured to identify a perceptible artifact in each video frame, to determine a noise patch to mask the artifact, and to create a set of noise parameters for each frame that define the noise patch; and
a multiplexer configured to combine the coded frame and associated noise parameters in a stream of video data to be output to a channel.

33. The video coder of claim 32, further comprising: a decoding unit configured to decode the coded sequence of frames as recovered video.

34. The video coder of claim 32, wherein the noise parameters include an amplitude of the determined noise patch.

35. The video coder of claim 32, wherein the noise parameters include spatial characteristics of the determined noise patch.

36. The video coder of claim 32, further comprising: a noise patch database coupled to the noise estimator, the database for storing a plurality of predefined noise patches.

37. The video coder of claim 32, further comprising: a scalar unit configured to scale the determined noise patch.

38. The video coder of claim 32, further comprising: a noise patch creator configured to create a new noise patch to mask the identified artifact.

39. A video decoder, comprising:
a demultiplexer configured to separate coded video data from associated noise parameters received on a channel
a decoding engine configured to decode the coded video data; and
a noise estimator configured to identify a perceptible artifact in each frame of the decoded video data, to identify a noise patch corresponding to the noise parameters associated with each frame, and to merge the noise patch with the frame.

40. The video decoder of claim 39, wherein the noise parameters include an amplitude of the determined noise patch.

41. The video decoder of claim 39, wherein the noise parameters include spatial characteristics of the determined noise patch.

42. The video decoder of claim 39, further comprising: a noise patch database coupled to the noise estimator, the database for storing a plurality of predefined noise patches.

43. The video decoder of claim 39, further comprising: a scalar unit configured to scale the determined noise patch.

44. The video decoder of claim 39, further comprising: a noise patch creator configured to create a new noise patch to mask the identified artifact.
